(19) United States
(12) Patent Application Publication
(10) Pub. No.: US 2010/0211878 A1
(43) Pub. Date: Aug. 19, 2010

(54) SELF INSTALLING NETWORK COMPUTER-PERIPHERAL DEVICE

(75) Inventors: Johannes E. SPIJKERBOSCH, Tiel (NL); Rob Kersemakers, Sittard (NL); Dion F. Slijp, Nijmegen (NL); Dick W.C.P. Van De Meulengraaf, Meerlo (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V., Venlo (NL)

(21) Appl. No.: 12/717,463

(22) Filed: Mar. 4, 2010

Related U.S. Application Data
(63) Continuation of application No. PCT/EP08/61792, filed on Sep. 5, 2008.
(60) Provisional application No. 60/935,890, filed on Sep. 5, 2007.

(51) Int. Cl. G06F 15/177; G06F 3/01

(52) U.S. Cl. 715/735; 709/222

(57) ABSTRACT

A method for configuring a network computer-peripheral device, and a network computer-peripheral device, such as a printer or scanner, includes a configuration tool for programming network settings into the device. The device includes a network scanning unit configured to scan a computer network to retrieve at least one network setting. The configuration tool is adapted to program the retrieved at least one network setting into the device, and the device itself is configured to execute the configuration tool.

### CROSS-REFERENCE TO RELATED APPLICATIONS

This application is a Continuation of International Application No. PCT/EP2008/061792, filed on Sep. 5, 2008, and for which priority is claimed under 35 U.S.C. §120, and which claims priority under 35 U.S.C. §119(e) to U.S. Provisional Application No. 60/935,890, filed on Sep. 5, 2007. The entirety of each of the above-identified applications is expressly incorporated herein by reference.

### BACKGROUND OF THE INVENTION

1. Field of the Invention

The present invention relates to a network computer-peripheral device, adapted to program network settings into the device. The present invention furthermore relates to a method for configuring a network computer-peripheral device, such as a printer or scanner or a similar multi-function device. The term “configuring” is used here for installing and setting up the device, in other words, preparing it for its intended use.

2. Background of the Invention

When a printer/scanner or similar multi-function device (MFD) is installed at a customer site, after being physically placed at the desired location, and connected to the local network, it must be configured to cooperate with the various services that together form the customer's network environment, such as print servers, LDAP servers, mail servers, etc. This is necessary for the communication needed for the MFD's intended usage, like receiving print jobs from workstations or print servers, exporting scan jobs to file servers or to e-mail addresses, MFD management from control applications, user identification and user authentication by database, and so on.

According to the state of the art, a network computer-peripheral device is physically connected to a local network and afterwards configured using an installation tool present on a computer connected to the computer-peripheral device via the network. Such an installation tool discovers the newly connected device on the network and then configures it for communication with the network environment.

A disadvantage of this known procedure is that it takes two separate steps, usually even at different locations, and that it requires access to a computer on the network, for configuring the device. In general, access to a computer on the network is restricted to a local IT administrator, and the physical installation of the device is performed by a mechanic. A further disadvantage is that configuring of a network computer-peripheral device is considered as a difficult technical task that requires more than average knowledge of IT infrastructure, and requires a lot of specific location- and network-dependent data, which may not be easily available or accessible to all. It is therefore a goal of the present invention to simplify the procedure for configuring a network computer-peripheral device.

### SUMMARY OF THE INVENTION

The present invention is directed to a network computer-peripheral device and a method for configuring such a device.

The network computer-peripheral device may for example be a printer or scanner, in particular an MFD, comprising a configuration tool for programming network settings into the device; and a network scanning unit configured to scan a computer network to retrieve at least one network setting, wherein the configuration tool is configured to program the at least one retrieved network setting into the device, and wherein the device itself is configured to execute the configuration tool.

The network computer-peripheral device according to the present invention thus offers the advantage that it can be installed (i.e. both physically connected and configured) in one single procedure, to be performed on the spot of the new device itself, and no personnel access to computers on the network is required. It is noted that a device may be connected to the network by a physical connection (a cable) or a wireless connection, such as IR, blue tooth, WIFI, etc.

The configuration tool is configured to scan a computer network to which the device is coupled, to retrieve possible network settings. These settings are specific for each local network, and are usually specified by a network administrator. When the network configuration is found/approved, the device automatically configures itself in accordance with the network configuration. In the art, a mechanic who installs the device at a specific location, may not have all required information in detail, or he may not have the technical skills to perform such detailed installation. This problem may be aggravated if the required information turns out to be undocumented, inaccurate or hard to find. This results in an undesired increase in installation time and the corresponding costs. When the configuration tool scans the network for these settings, no technical input or details from a system administrator are required, since the device retrieves this information itself. As a result a new device can be moved into place, connected and installed by a single person, who could even be the truck driver delivering the device, since almost no specific technical knowledge or details need to be known to configure the device. Since it is possible that the scan yields more than one possible option for a certain setting, the configuration tool may collect several possible values for a certain setting.

The device may initialize the network scanning unit and the configuration tool upon powering-up the device. As a result, the configuration of the device can take place directly after the physical connection. As an alternative, the configuration tool may be launched by a user who wants to configure the device.

Nowadays, most computer networks make use of the Ethernet-protocol or the internet protocol. Scanning these computer networks can be effectively done by performing a DNS query, or an IP-range scan. These methods are mentioned as an example only. Other methods, such as multicast DNS (mDNS) are equally conceivable for the skilled person.

In the state of the art, a configuration tool run on a computer on the network performs such a scan, in order to detect new computer-peripheral devices on the network. Since it is unknown to the configuration-tool upfront how many new devices there will be plugged-in, and which IP addresses they will have in use, in general, the complete possible IP range of the network must be scanned. Such scans are however a heavy load to the digital traffic on the network. Performing the scan from the computer-peripheral device now offers the additional advantage that the scan can be terminated as soon as all of the required information has been found.

This is in particular applicable when the scanning unit is configured to identify a printer management tool incorporated in the computer network, and to retrieve at least one network setting (but preferably all network settings) from said printer management tool. As soon as the location of printer management tool is determined, data can be retrieved from the application, and the scan can be terminated. In another embodiment of the present invention, the device logs on to the printer management tool, and stores information about itself in the tool, or it stores at least part of its settings in the tool.

As an alternative or as an addition, the device may be adapted to obtain configuration settings from a peer device.

In order to configure the device for its tasks, one or more of the following details may be needed:

a DHCP (Dynamic Host Configuration Protocol) server;

a SMB (Server Message Block) server;

a unicast or multicast DNS (Dynamic Name Server);

an LDAP (Lightweight Directory Access Protocol) server;

a mail server;

a proxy server; and

a WINS server.

In an embodiment, the device comprises a user interface including visualizing unit such as a display for displaying the at least one retrieved network setting. Herewith, the user can decide whether to accept or decline proposed settings, found and/or determined by the device. When the user declines settings proposed by the device, the device may be configured to continue its scan in order to obtain another possible value, or it may provide the user with the option to enter data manually. In the latter case, the user needs to know at least some technical details of the location. The device may—especially in this case—comprise a wizard, to guide the user in entering configuration data into the device.

In many situations, the described discovery techniques yields more than one possibility for a given configuration item. For instance, the network infrastructure may contain more than one email server and so more than one may be found. In these cases the device may not decide itself which to use but leave the choice to the user that installs the device. Thereto, the device may be configured to display a list of options, possibly sorted on the basis of at least one predefined criterion.

As the purpose of this invention is to minimize the installation effort, presenting just the collection of discovered values is not sufficient. Therefore, a ranking of discovered values is added: the discoveries are always presented in lists, while the contents of these lists are sorted on the likelihood of correctness. The values that are most probably correct are placed on top which makes these also the most easy to select. For this, a number of sorting techniques may be used.

For instance, values may be sorted and stored based on the way they are discovered: for instance the values obtained by a DHCP lease are more significant than a value obtained by a SMB query. This is because the persons that configured the DHCP server had the intention that these values would actually be used.

Sorting may also be performed based on priority indicators that are received along with the values, for instance values obtained by DHCP or DNS have their corresponding priority numbers. These numbers are used for sorting the values before storing these as a list. DNS for example may herein have a higher priority indicator than SMB.

Sorting may also be performed based on techniques described in so called Request For Comment documents (RFC's), for instance the technique described in the standardized RFC2247 (Using Domains in LDAP/X.500 Distinguished Names) that ranks the LDAP base distinguished name that is the most similar to the TCPIP domain name as the most relevant.

Sorting may further be performed by assuming that the most often used data or settings are the most significant. For instance in the SMB domain discovery it is counted how many computers are member of a domain in the local network environment. The domains with the largest number of computers are then regarded as the most significant.

Sorting may also be performed by comparing values to the contents of a dictionary. For instance, the names of LDAP attributes have a tendency to be equal to the default names a vendor of LDAP servers has given them, and so these well known attribute default names are listed in dictionaries. If a discovered name is found in a dictionary for that particular item, or at least looks like it, the value will be ranked higher.

Sorting may be performed by finding similarities of what are expected values. For instance, the contents of LDAP attributes may be an email address, a person's name or a person's telephone number. By examining samples of the contents of these attributes, it is determined on what scale these have similarities with email addresses, person's names or person's telephone numbers. The attributes that contain the values that are the most similar are the most significant. Those that are not similar at all are omitted from the list.

For example, the string “F.G. Somename” looks like a name because the position of the single capital characters F and G, the position of the dots in-between, the fact that that last word starts with a capital- and is followed by lower case characters, it contains no digits, and so on. The more the samples look like regular names, the higher the ranking.

The device may further comprise a user interface module, including a local user interface provided with a visualizing unit, such as a display, and/or a web server for generating a website to be visualized by (possibly remote) a visualizing unit, said website comprising a user interface of the device. The user interface can be displayed on a screen, for example a touch screen, on the device, but it can also be approached by browsing to the IP address of the device via the network.

The device can furthermore be configured to browse for software updates, after being configured. In this way, the device stays up-to-date with manufacturer's developments.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:The invention will now be explained in more detail with reference to the appended drawings, wherein:

FIG. 1 shows a computer network with a Multi Functional Device (MFD) such as a printer, according to the present invention;

FIGS. 2a-2l show user interface screens of the installation wizard;

FIG. 3 shows an example of configurable items, presented on the user-interface of the device;

FIGS. 4a-4d show the various discovery techniques that can be used;

FIG. 5 shows scanning for devices by a configuration tool;

FIG. 6 shows discovering devices via a multicast in the subnet; and

FIG. 7 shows how the devices automatically find an IT-suite.

### DETAILED DESCRIPTION OF THE PREFERRED EMBODIMENTS

The present invention will now be described with reference to the accompanying drawings, wherein the same reference numerals have been used to identify the same or similar elements throughout the several views.

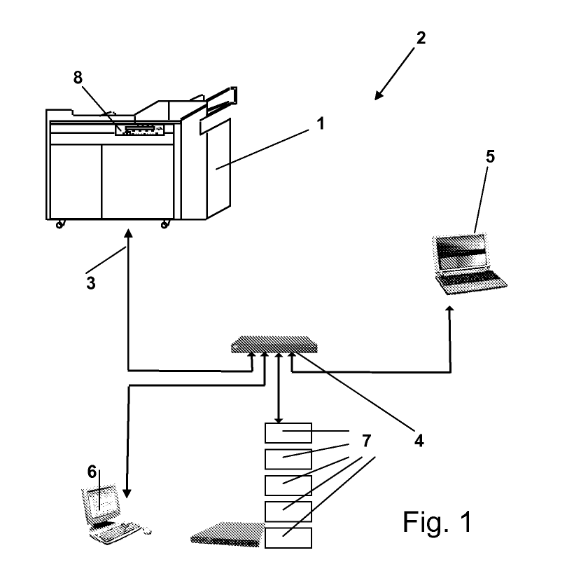

FIG. 1 shows a printer and scanner multi-functional device (MFD) 1, in a network environment 2. The multi-functional device 1 is physically connected to the network by cable 3, which is connected to a hub 4. In order to configure the device 1, a configuration tool is executed on the device 1 itself, as soon as the device 1 is powered up, and detects that no network settings are present. The MFD 1 has a user interface with a display 8.

The configuration tool performs a DNS query, or an IP-range scan on the computer network 2 to which the device 1 is coupled, to retrieve possible network settings for the configuration of the device 1. A network administrator may have added a reference to a location of a device-configuration application to a DNS-tree of the network 2, in order to facilitate the scanning process.

As soon as the device 1 has determined the presence of a device-configuration application 5, it retrieves settings from said location. If there is no such device-configuration application 5, the configuration tool run on device 1 scans the network 2 to obtain the settings 7 of the DHCP (Dynamic Host Configuration Protocol) server, the SMB (Server Message Block) server, the unicast or multicast DNS (Dynamic Name Server), the LDAP (Lightweight Directory Access Protocol) server, the mail server and the proxy server present on the network.

When the configuration tool of the device 1 has retrieved the required settings, it displays configuration options to a user via display 8. The retrieved settings are listed as an option to be confirmed by an operator who installs the device. After the settings have been confirmed and the device properly installed, a user of PC 6 on the network can for example send print-jobs to the device 1.

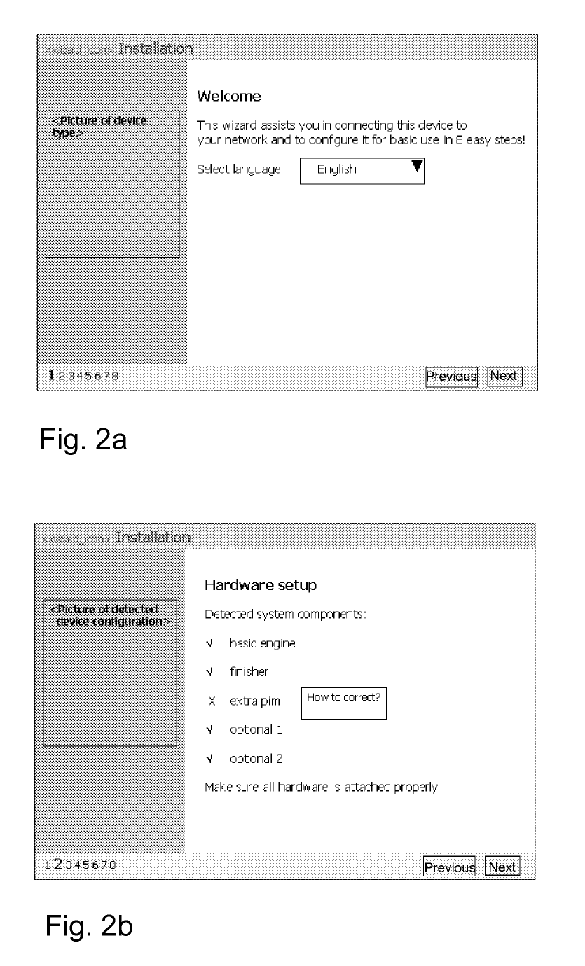

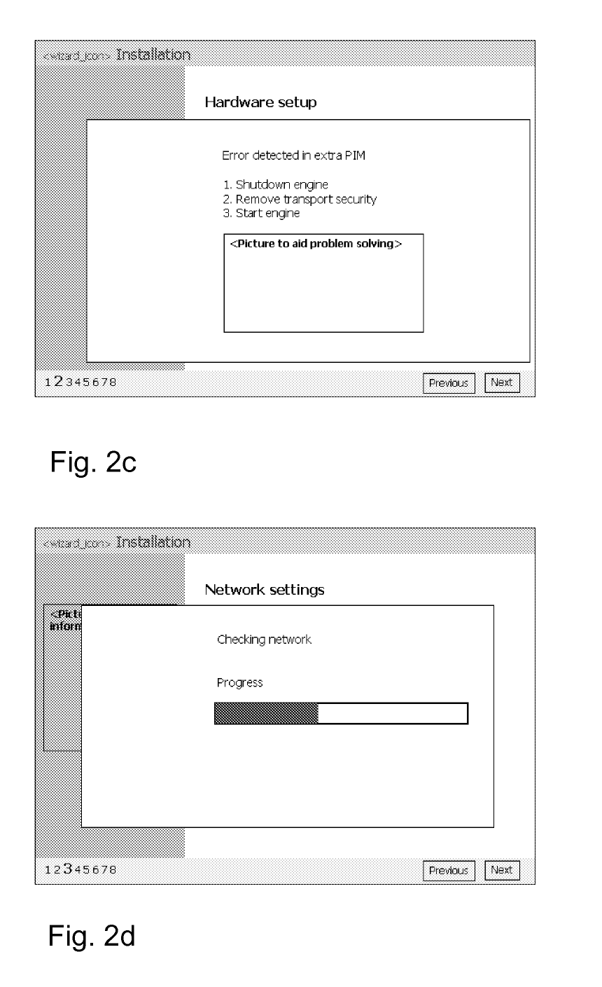

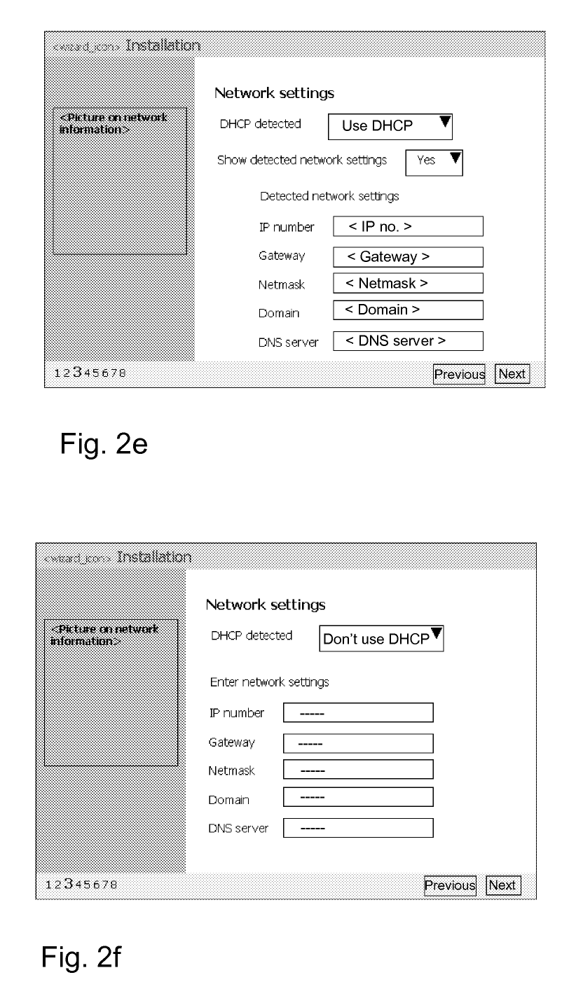

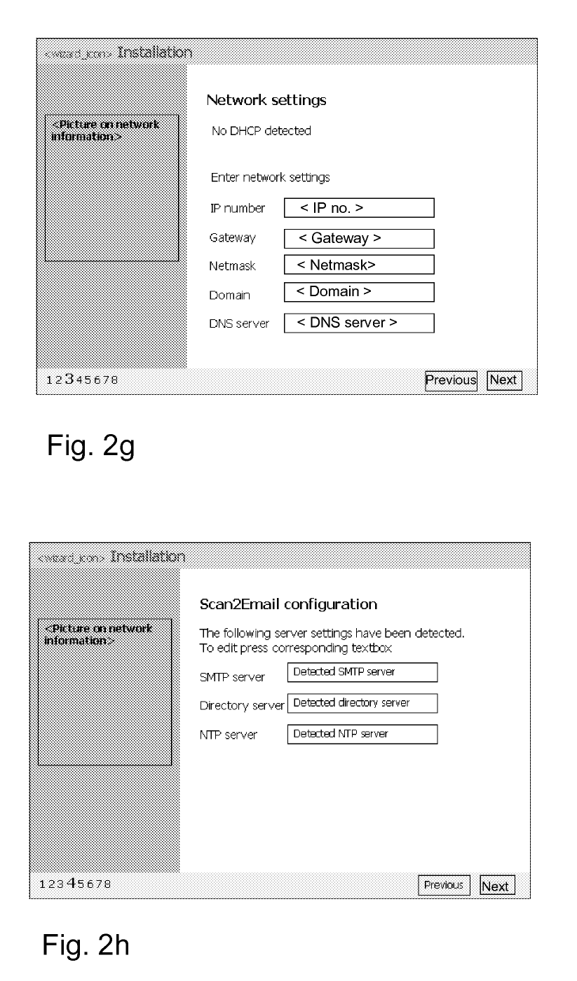

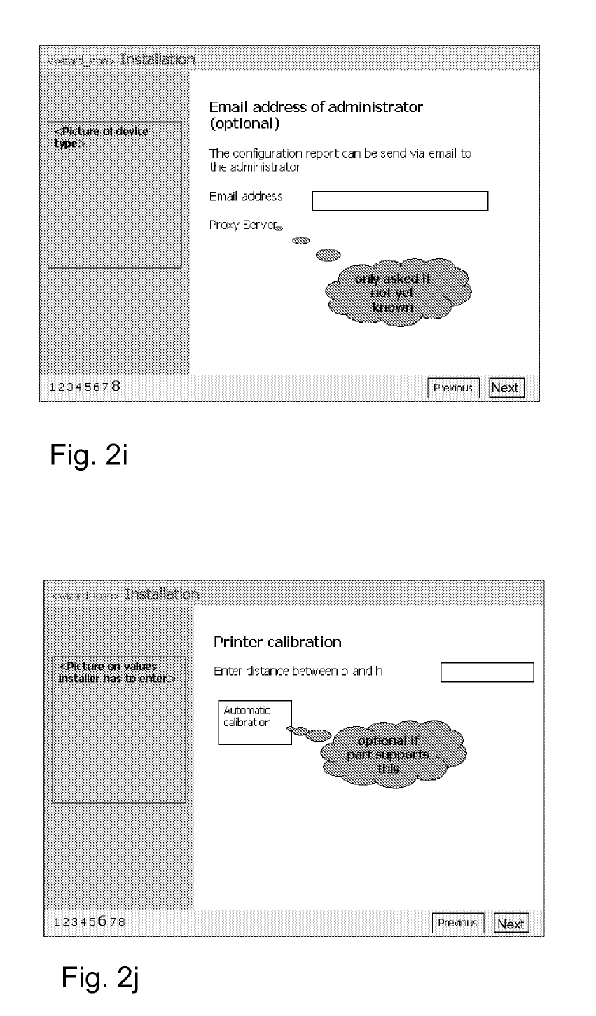

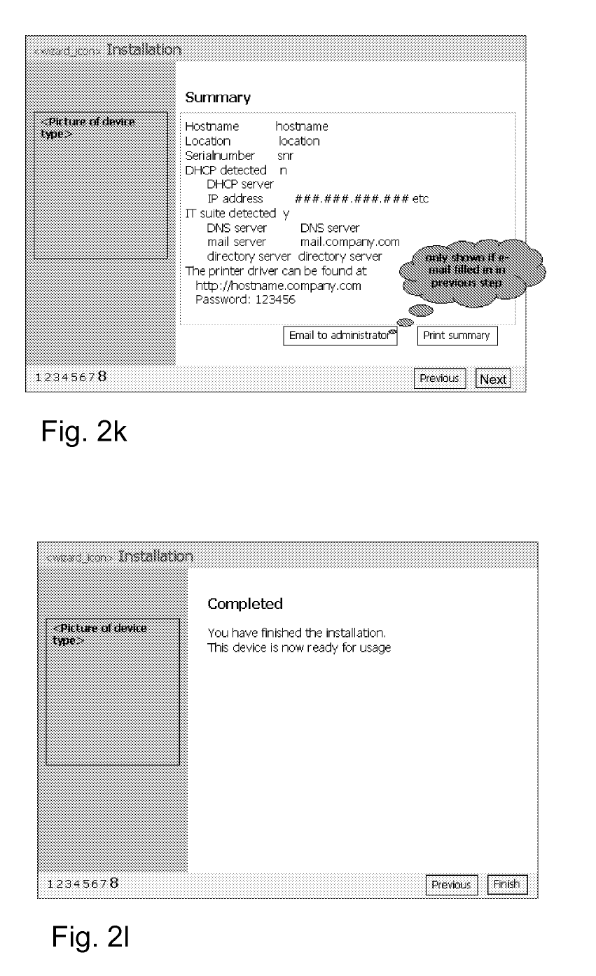

FIG. 2a shows a first user interface screen of an installation wizard as it can be displayed on a display 8 of a device according to the present invention. The first screen shows a list box for selecting a language of the installation.

FIG. 2b shows a second user interface screen, wherein results of a self-test of the device are displayed. These results relate to the hardware-configuration of the device, and do not comprise specific network configuration settings yet. The screen text mentions an error in the “extra pim” (pim=paper input module). A help-function is available to assist the user in solving the hardware error.

FIG. 2c shows a screen that is displayed when the help-function related to the hardware error shown in FIG. 2c is initiated.

FIG. 2d shows a screen that is displayed after successful results of a self-test according to FIG. 2b have been displayed. The device starts scanning the network for configuration-settings, and shows the progress thereof to the user.

FIG. 2e shows the screen that is displayed when the network scan is finished. The screen shows the parameters for which values have been found, and the values themselves. The screen shows that a DHCP server has been detected. In that case, the DHCP server assigns values for the network interface of the device (the entries shown in FIG. 2e).

The operator may also choose not to use the DHCP server, by clicking on the “Use DHCP” box in FIG. 2e, whereupon a menu opens including the option “Don't use DHCP”. In that case, the operator must himself enter the network interface information.

FIG. 2f shows the screen that is displayed when DHCP is not used, and the user has touched one of the boxes from the screen of FIG. 2e. A box is displayed, in which the user must manually enter a value, such as the IP number he wants the device to have, or the standard gateway of the network. The same screen would have been shown if no DHCP server was detected.

FIG. 2g shows a screen that is displayed after the network settings have been configured, with or without DHCP.

The following step is configuration of the Scan2Email service (for sending scanned images to a user's email address).

FIG. 2h shows a screen that is displayed, showing values that have been detected during the earlier scan for network settings.

FIG. 2i shows a screen for entering the e-mail address of the network administrator.

FIG. 2j shows a screen that is displayed after a test page of the calibrated device is printed. The user is prompted to enter values that correspond to the print results. Based on these values, the device adjusts its own settings, if necessary.

FIG. 2k shows a screen that presents the user an overview of the configuration. An option to print the results is offered.

FIG. 2l shows the screen that is displayed to the user to confirm that the configuration is completed.

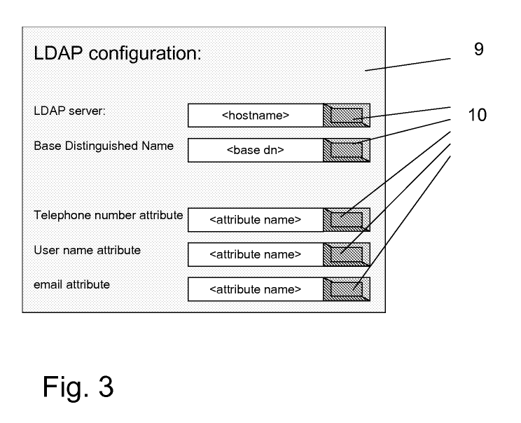

FIG. 3 shows a screen 9 on which the retrieved settings are listed, preferably ranked on their possible correctness as described above. The configuration tool may therein be a website comprising the user interface, run on the device. The website is adapted to have detected settings confirmed by a user. Therefore, the configuration tool shows combo boxes 10, with which the user can make a choice between the possible values the configuration tool has found.

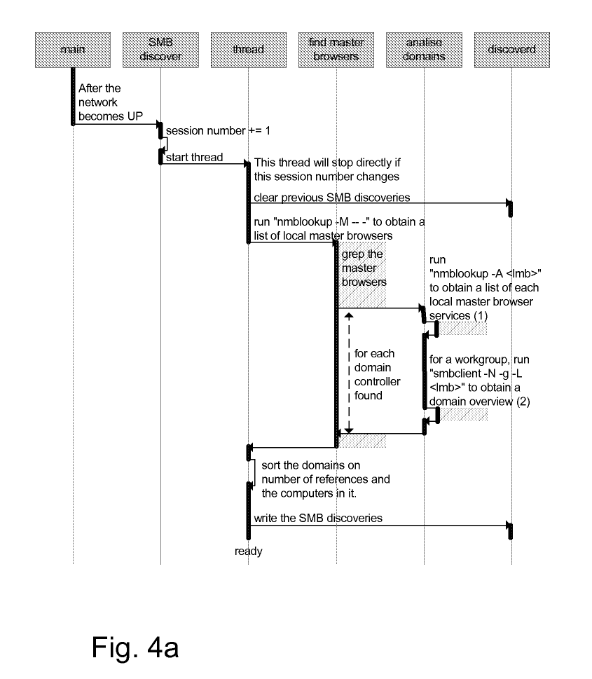

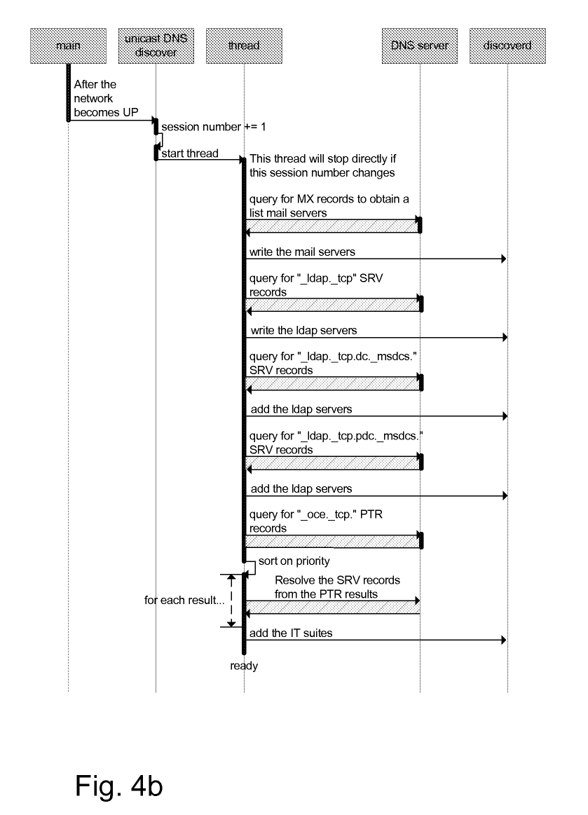

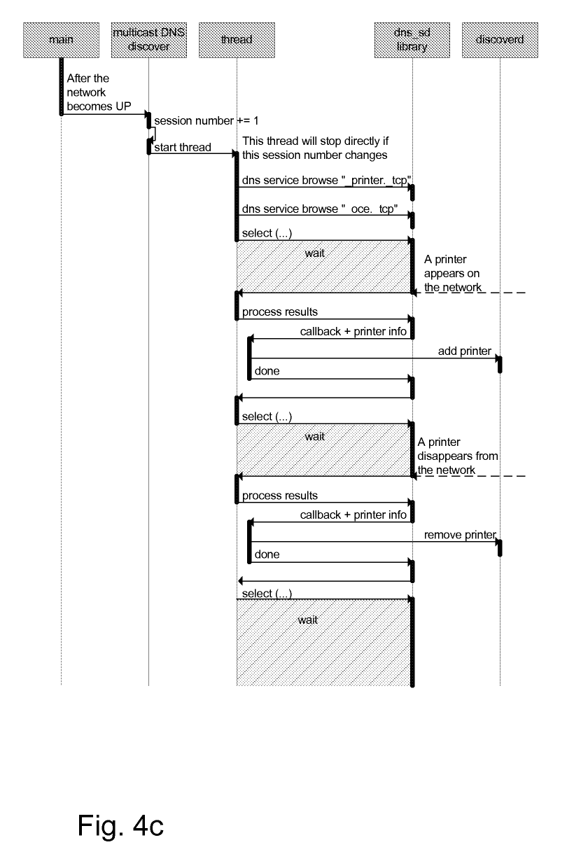

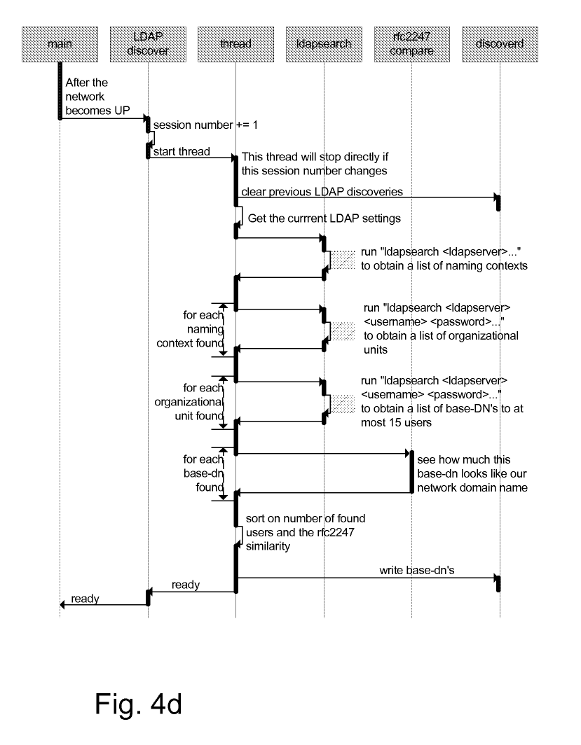

FIG. 4a shows discovery by SMB. A network protocol like LDAP or SMB may currently be de-configured but when the user switches these on, it is helpful to present suggestions on the base-DN and the WINS servers. The SMB discoveries main purpose is to find usable Microsoft Network domain names, but it might find other useful data too.

One SMB discovery session will run when the network becomes UP. As this session may take a few minutes, this is performed in a separate thread. In these minutes the network may go down and up again. Then, the old session must be stopped and a new one must be started. Stopping is accomplished using a session number variable that is specific for the SMB discovery. If its value changes, a running session must stop as soon as possible.

The thread will run “nmblookup —M -- - 2>&1” to obtain a list of all local master browsers in the subnet. This will return an output like:

querying _MSBROWSE_{—} on 192.168.2.255
192.168.2.4 _MSBROWSE_<01>
192.168.2.5 _MSBROWSE_<01>

Each IP address indentifies a local master browser (called lmb from now on). For each of these lmb's, “nmblookup —A <1 mb>2>&1” is called. This returns the services of this lmb like:

```
Looking up status of 192.168.2.4
  * HSW-BUILDPC <00> - M <ACTIVE>
  * HSW-BUILDPC <20> - M <ACTIVE>
  * HSW <00> - <GROUP> M <ACTIVE>
  * HSW <1e> - <GROUP> M <ACTIVE>
  * HSW <1d> - M <ACTIVE>
  * .._MSBROWSE_. <01> - <GROUP> M <ACTIVE>
```

In particular the <nn> part of the output is relevant, this defines the type of the service.

What we are interested in for now is:
“NT-domain <1c>”: Domain Controller

This name identifies a Domain Master Browser (DMB). This may well be a

“machine <22>”
“machine <22>”
“machine <23>”
“machine <6a>”
“machine <97>”: Microsoft exchange

WINS server.

This may be a usable mail server.
“Workgroup <1d>”: Local Master Browser

This name identifies the Local Master Browser (LMB, sometimes called simply “Master Browser”) for a subnet. This means that this computer is actually a local master browser. For each of these, “smbclient —N —g —L <lmb> -d0 2>&1” is called, which will result in something like:

Server|hsw-0254|
Server|buildpc|
Server|printer11|
Workgroup|HSW|pc12
Workgroup|OCE|dar

This gives us what we need for the domain names. First, it gives the number of computers this lmb knows about in the domain it manages. Second, it lists the other domains this lmb knows about.

All domains we find this way are added to a list, along with a reference counter with the value 1, and with the number of computers we have just found in this domain. As this may be executed for each lmb in this subnet (and there may be quite a lot of these), a domain may already be in the list. In this case, we increase the reference count and add the new number of computers found.

At the end, we need to sort the list of domains to get the most usable ones on the top. A sorting method is used in which the domains are first sorted on the reference count, and second on the number of computers in the domain. After this, the domains are stored in the discovery storage.

FIG. 4b shows a Unicast DNS discovery, a DNS RR for specifying the location of services according to RFC2782. The DNS discovery main purpose is to find usable IT-suites, mail- and LDAP-servers, but it might find other useful data.

One unicast DNS discovery session will run when the network becomes UP. As this session may take a few minutes (only in case of network errors), this is performed in a separate thread. In these minutes, the network may go down and up again. Then, the old session must be stopped and a new one must be started. Stopping is accomplished using a session number variable that is specific for the unicast DNS discovery. If its value changes, a running session must stop as soon as possible.

The thread will use the “res_query” function in the standard C library, which will usually respond very quickly.

First, the unicast DNS query will query for MX records, which will usually result in a list of SMTP server addresses, along with the priority of each. The results are sorted and written into the discovery storage.

Next, the unicast DNS query will query for SRV records with “_ldap._tcp.<domain>”, “_ldap._tcp.dc._msdcs.<domain>” and “_ldap._tcp.pdc._msdcs.<domain>” as fully qualified domain names. This will usually result in a list of LDAP server addresses, the first for ‘normal’ ldap servers, the rest for the MS (AD) ldap servers. The results are sorted and written into the discovery storage.

Finally, the unicast DNS query will query for PTR records with “_oce._tcp.<domain>” as fully qualified domain names. This may result in pointer records to the SRV records for the IT suites in a client infrastructure. These SRV records are resolved in a second query. The results are sorted and written into the discovery storage.

Commonly used server names are used in a dictionary scan. RFC2782 states in the usage rules that if the SRV record of QNAME_service._protocol.target can not be found, the A record of the target may be looked up. This means, looking up the address of “ldap.example.com”. Building on this technique, a small dictionary is used with, e.g., the following entries:

| | | | |
|---|---|---|---|
| Mail server names: | “smtp” | “mail” | “email” |
| | “e-mail” | “correo” | “correio” |
| | “posta” | “post” | “courrier” |
| | “e-post” | “e-postserver” | |
| LDAP servers names: | “ldap” | | |
| Scan server names: | “intralogic” | “scan” | “ftp” |
| Time server names: | | “nntp” | “time” |
| Wins server names: | “wins” | | |

This will do in many small size infrastructures. Other entries may be contemplated. However in medium size infrastructures one will often see extensions to the name like ldap1 or ldap-1. In large size infrastructures one will often see extensions to the name like ldap01 or ldap-01. Therefore each entry is combined with the following extensions:

| “” | | | |
|---|---|---|---|
| “1” | “2” | “3” | “4” |
| “01” | “02” | “03” | “04” |
| “−1” | “−2” | “−3” | “−4” |
| “−01” | “−02” | “−03” | “−04” |

All these combinations are queried for as soon as the network goes up. As this can generate a lot of network traffic, it may be slowed down to, e.g., 33 or less queries per second.

FIG. 4c shows a Multicast DNS discovery. The DNS discovery's main purpose is to find usable printers for the smart mailbox and other equipment (like an IT suite) that advertise themselves over mDNS, but it might find other useful data too (in a later stage).

One multicast DNS discovery session will run when the network becomes UP. This session will keep running as long as the network is up, and so it gives a live overview of the printers/equipment on the network. The discoveries are performed in a separate thread. The network may go down and up again. Then, the old session must be stopped and a new one must be started. Stopping is accomplished using a session number variable that is specific for the multicast DNS discovery. If its value changes, a running session must stop as soon as possible.

The thread will use the “dns_sd” library that is part of ‘Bonjour’ zero configuration from Apple Inc. It asks this library to look for the types “_oce._tcp” and “_printer._tcp.”. The service type ftp, ifolder, kerberos, ldap, ntp, rfid, soap, webdav and more may also be useful.

The multicast discovery differs from the other discovery methods in duration. As the network environment is not only about servers, but printers & computers as well, it is much more dynamic. As there is no single time that the discovery is ready, the multicast DNS discovery will be running as long as the network is up. As this is a very efficient protocol, this will not give a substantial performance penalty.

The discovery also differs from the others because it not only detects the services that are available but also those that disappear, so the list of discovered values can grow and shrink over time.

FIG. 4d shows an LDAP discovery. The LDAP discovery's main purpose is to find usable LDAP base-dn and attribute names, but it might find other useful data too.

One LDAP discovery session will run when the user selects a LDAP server, or if one LDAP server is already configured. As this session may take a few seconds, this is performed in a separate thread. In these seconds, the network may go down and up again. Then, the old session must be stopped and a new one must be started. Stopping is accomplished using a session number variable that is specific for the LDAP discovery. If its value changes, a running session must stop as soon as possible.

The thread will first run “ldapsearch —b —LLL —l7 —s base ‘objectclass=*’ namingContexts —h<ldaphostname> -z25 2>&1” to obtain a list of all NamingContexts of this LDAP server.

The values of this attribute correspond to naming contexts which the LDAP server masters or shadows. If the server does not master any information (e.g. it is an LDAP gateway to a public X.500 directory) this attribute will be absent. If the server believes it contains the entire directory, the attribute will have a single value, and that value will be the empty string (indicating the null DN of the root). This attribute will allow a client to choose suitable base objects for searching when it has contacted a server. This information is usually public, meaning that no authorization is needed to obtain it.

This ldapsearch will return an output like:

dn:
NnamingContext: o=deltree
namingContext: o=NetscapeRoot
namingContext: o=Oce

For each of these, run “ldapsearch —b —LLL —l7 —b <namingContext> —s sub ‘objectclass=organizationalUnit” dc —h<ldaphostname> -D<loginname> -w <password> -z25 2>&1″ to obtain a list of all base-dn's this ldap server contains in a namingContexts. This may, e.g., return the base-dn's like:

dn: ou=NederlandBV_NL, o=Oce
dn: ou=IndustriesSA_FR, o=Oce
dn: ou=people, ou=NederlandBV_NL, o=Oce
dn: ou=people, ou=IndustriesSA_FR, o=Oce
dn: ou=OtherCountries, o=Oce
and probably more.

The problem with this list is that many base-dn's do not contain any information on people, or only a few entries to describe the creator or administrators. Therefore, this list is not very useful. A next stage is necessary that looks if is there is actually a collection of people in a base-dn.

To distinguish a few creators and administrators from a collection of people, we query for the dn for 15 people (only the dn, NOT the information on these users). More than 15 is considered as a large collection. The number of 15 is given here as an example only. Depending on the circumstances, other values may be chosen.

For all base-dn's, we run “ldapsearch —b —LLL —l7 —b<namingContext> —s one ‘objectclass=person’ dc —h <ldaphostname> -D<loginname> -w<password> -z25 2>&1” to obtain a list of all base-dn's this ldap server contains in a namingContexts. For each of these, run “ldapsearch —b —LLL —l7 —b <namingContext> —s sub ‘objectclass=people” dc —h<ldaphostname> -D<loginname> -w<password> -z15 2>&1″ to obtain a list of maximum 15 dn's to people. This returns the dn's like:

dn: employeeNumber=123, ou=people, ou=Technologies,
o=Oce
dn: employeeNumber=124, ou=people, ou=Technologies,
o=Oce
dn: cn=am-overleg, ou=funct, ou=Technologies, o=Oce

Each line contains a base-dn referring to which of the people's information is collected, and each time a base-dn is encountered, it will have a reference counter increased. So, base-dn's referring to many people will have a high reference count.

RFC2247 suggests using network domain names in LDAP/X.500 distinguished names. This means that an organization might have implemented this and that the MFD's network domain name can give a clue when choosing a base-dn.

The practice is that these two are usually loosely related to each other, but can nevertheless give a hint on which base-dn is the most likely candidate.

Therefore there is a rfc2247-compare that finds out to what measure each base-dn looks like the network domain name. To present the administrator a list with base-dn's with the most likely candidate on top, the discovered list is sorted:

first the list is sorted on the number of people found in each base-dn

If this number of 2 base-dn's is equal (which will happen frequently as this software only counts to 15 people), then the list is sorted on rfc2247 similarity.

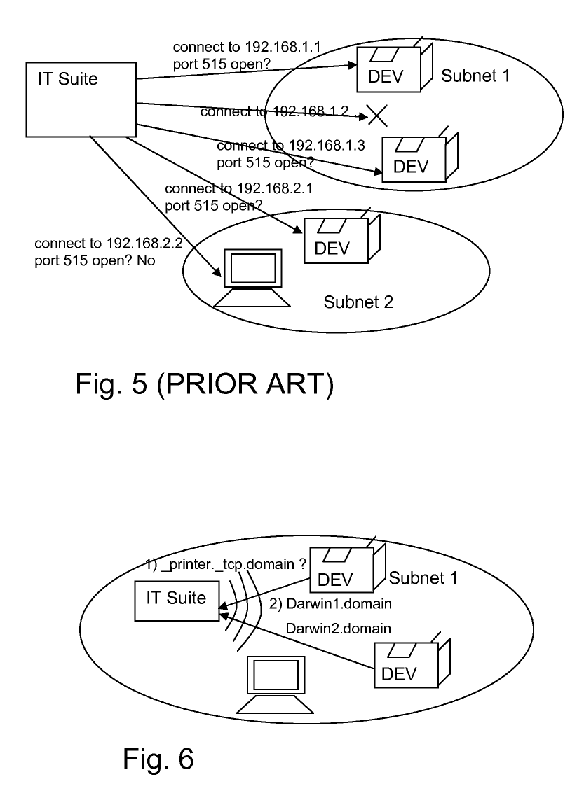

FIG. 5 shows scanning for devices by a configuration tool, referred to as IT suite, according to the background art. The traditional way to discover devices by an IT suite, is via a brute-force network scan. All devices in a certain network range, e.g. 192.168.11.1-192.168.11.254, are queried for a certain port or an SNMP object, as shown in FIG. 5.

This mechanism has the advantage that all devices in a certain range are queried, so in principal all devices should be found. The disadvantages are that it takes time to query all devices, if a device is not available during the scan (turned off, in error), it is not found and new devices are only discovered if the scan is done, not in the meanwhile.

FIG. 6 shows discovering devices in another way, via a multicast in the subnet. So called ZeroConf networking can be used for this. The suite transmits a multicast DNS package in the subnet for a certain service. The devices that offer that service reply with the specific name of the service that matches, as shown in FIG. 3.

The advantage is that this mechanism puts a lesser constraint on the network and therefore can be done more often (in time), which increases the chance to find new devices (which were turned off or in error). It also is more or less instant. The drawback is that in most cases this works only within a subnet.

For ZeroConf networking a Service Definition has been registered at IANA, namely _oce._tcp by Applicant. This SD can be used for device discovery by the suite, but also for discovery of the suite by devices and devices by devices, as proposed by an embodiment of the present invention as described below.

Both mechanisms described above have the advantage that no additional action has to be taken at the device to accomplish them.

Discovery by the IT-suite implied some sort of scan for devices. Most of theses scans are quite obtrusive and therefore not favored by IT administrators. Also the devices are only discovered when the scan is performed, while the suite is available all the time. Therefore, an embodiment of the present invention proposes another approach wherein the devices discover the IT-suite.

At the device, the IP-address or hostname can be filled in, enabling the device to contact the suite. This is a mechanism that works fine, but it has the disadvantage that a person (preferably the truck driver who delivered the device or the customer) who installs the device has to know the ip-address or hostname of the suite.

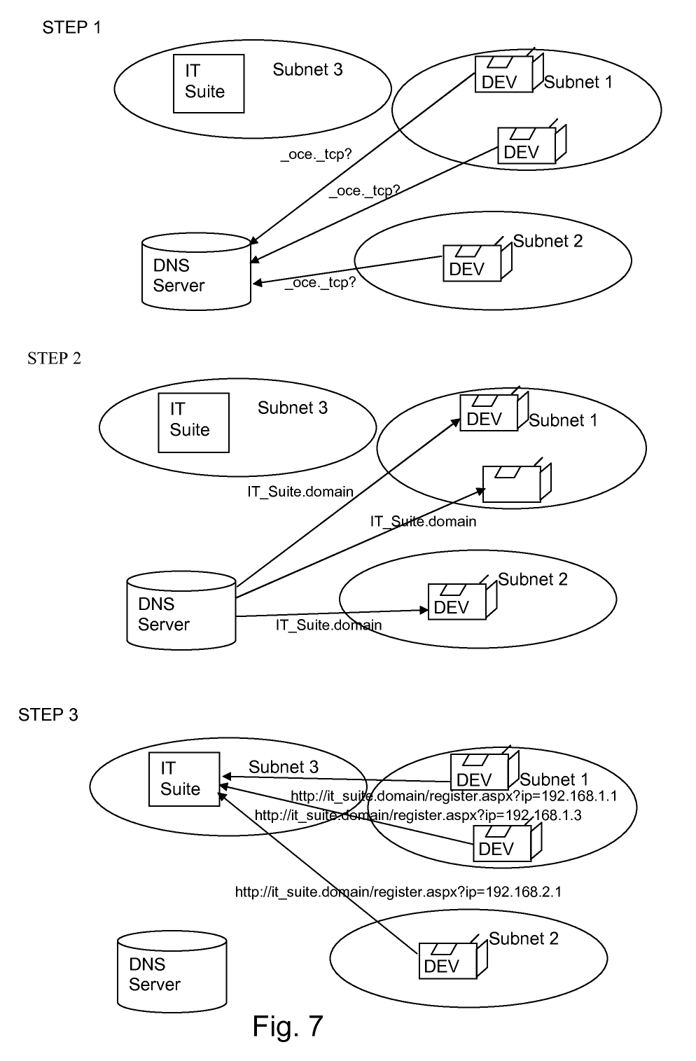

In an embodiment of the present invention, the devices are programmed to automatically find the IT-suite, thereby avoiding the above manual step. This is shown in FIG. 7. This can be done by using a standard DNS server. Only one manual step has to be done then at installation of the suite by an IT administrator (or none if the DNS server supports dynamic updates). Two records have to be added to the DNS tree, SRV and a PTR record that enable the multi-functionals to discover the suite themselves. SRV records are often added in a Windows-based network to enable workstations to find the domain controllers.

As shown in FIG. 7, in STEP 1, one or more devices DEV ask the DNS server for the IP address of the IT-suite. Next, in STEP 2, the DNS server returns the requested IP address to the devices that asked for it. Then, in STEP 3, the devices contact the ITsuite and receive the network settings they need for their configuration.

Similar to device discovery in the subnet with ZeroConf by the suite, devices could discover the suite. In that case, the suite should publish the _oce._tcp service and the multifunctionals should transmit a multicast package to discover the service.

As a backup, it is also possible to add the ip-address and hostname of the suite manually at the device, registration is then done against that host (step 3).

Next to that, letting the devices publish an _oce._tcp service would be most valuable. This would be no additional effort because they already publish a number of services e.g. _printer._tcp, to enable Bonjour printing. It enables a speed up for discovery of devices within the subnet. Medium-sized companies, 200-500 employees, often have 1 subnet or companies have all the printers (for security reasons) on a separate subnet.

The same software, needed for the mechanism described in the paragraph above, can be used to let the suite publish itself via Bonjour. This would be a partial backup for situations in which no DNS server is present or the IT department does not want to add the additional records to their DNS server.

Discovery of the suite by the device, in the installation wizard, would be done in 3 steps:

1. Via DNS, a query is done to see if the IT suite is present.
2. If no suite is found in step 1, an identical multicast DNS query will be done to see if an IT suite is present in the subnet.
3. If no suite is found in step 2, the user is presented with a dialog to manually provide the ip-address or the hostname of the IT suite.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A network computer-peripheral device, comprising:
a configuration tool for programming network settings into the device; and
a network scanning unit configured to scan a computer network to retrieve at least one network setting,
wherein the configuration tool is configured to program the at least one retrieved network setting into the device, and wherein the device itself is configured to execute the configuration tool.

2. The device according to claim 1, wherein the device is configured to initialize the network scanning unit and the configuration tool upon powering-up the device.

3. The device according to claim 1, wherein the network scanning unit is configured to perform a DNS query, or an IP-range scan.

4. The device according to claim 1, wherein the network scanning unit is configured to identify a printer management tool incorporated in the computer network, and to retrieve at least one network setting from said printer management tool.

5. The device according to claim 1, wherein the network scanning unit is configured to retrieve at least one of the following network settings:
a DHCP (Dynamic Host Configuration Protocol) server;
a SMB (Server Message Block) server;
a unicast or multicast DNS (Dynamic Name Server);
an LDAP (Lightweight Directory Access Protocol) server;
a mail server;
a proxy server; and
a WINS server.

6. The device according to claim 1, further comprising a user interface including a visualizing unit configured to display the at least one retrieved network setting.

7. The device according to claim 6, wherein the visualizing unit is configured to display a list of configuration options to be confirmed to a user.

8. The device according to claim 7, wherein the device is configured to sort the list based on at least one predefined criterion.

9. The device according to claim 6, further comprising a web server for generating a website for remote access, said website comprising a user interface of the device.

10. A method for configuring a network computer-peripheral device, the network computer-peripheral device comprising a configuration tool for programming network settings into the device, said method comprising the steps of:
scanning a computer network in which the device is incorporated to retrieve at least one network setting;
executing the configuration tool on the device itself; and
programming the at least one retrieved network setting into the device with the configuration tool.

11. The method according to claim 10, further comprising the step of initializing the scanning process if no network setting is present upon powering-up the device.

12. The method according to claim 10, wherein the network scanning comprises the step of performing a DNS query or an IP-range scan.

13. The method according to claim 12, further comprising the step of adding a reference to a location of a device-configuration application to a DNS-tree of the network.

14. The method according to claim 10, further comprising the steps of locating a device-configuration application, and subsequently retrieving settings from said device-configuration application.

15. The method according to claim 10, further comprising the step of retrieving at least one of the following network settings:
a DHCP (Dynamic Host Configuration Protocol) server;
a SMB (Server Message Block) server;
a unicast or multicast DNS (Dynamic Name Server);
an LDAP (Lightweight Directory Access Protocol) server;
a mail server; and
a proxy server.

16. The method according to claim 10, further comprising the step of displaying to a user a list of retrieved network settings as an option to be confirmed.

17. The method according to claim 16, further comprising the step of sorting the list based on at least one predefined criterion.
